(19) United States
(12) Patent Application Publication
(10) Pub. No.: US 2005/0252327 A1
(43) Pub. Date: Nov. 17, 2005

(54) Lower stress high torque gear to shaft mounting system

(75) Inventors: David K. Shogren, Ontario, NY (US); Tab A. Tress, Henrietta, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/847,152

(22) Filed: May 17, 2004

(51) Int. Cl. F16H 55/00; B23P 19/02

(52) U.S. Cl. 74/431; 29/893.2; 29/525; 29/894.325

(57) ABSTRACT

A non-slip frictional force-fit mounting of a plastic gear to a gear mounting shaft using a compliant tolerance ring between the shaft and gear, wherein the tolerance ring has a first circumferentially spaced pattern of varying radial dimensions and the gear has an annular interior mounting surface with a second circumferentially spaced pattern of varying radial dimensions cooperatively engaging within the first circumferentially spaced pattern of varying radial dimensions of the tolerance ring to provide a high torque rotational drive interconnection between the gear mounting shaft and the gear yet also have reduced gear material stress.

Disclosed in the embodiment herein is an improved system of mounting a gear (or pulley), especially one of molded plastic material, to a mounting shaft with a compliant tolerance ring between the mounting shaft and the gear for improved torque transmission between the shaft and the gear but with reduced internal gear or pulley stress, wherein the tolerance ring has a first circumferentially spaced pattern of varying radial dimensions and wherein the gear has an annular interior mounting surface with a second circumferentially spaced pattern of varying radial dimensions which cooperatively engages with said first circumferentially spaced pattern of varying radial dimensions of said tolerance ring when said gear is mounted to said gear mounting shaft. This can provide reduced gear material stress, yet a high torque and/or tight or low slop (low relative movement) rotational drive interconnection between the gear and the gear mounting shaft.

It is well known that pressure fit connections of gears to shafts can cause excessive internal stresses within the gear, especially if the gear is plastic, in the mounting process, and/or (as is often the case) the gear and its mounting shaft are of different materials with different coefficients of thermal expansion during uses exposed to temperature changes. Hence the known use of an intermediate tolerance ring to limit stresses applied to the gear. However, for a plastic gear in particular, with a requirement of a high torque rotational drive between the shaft and the gear, the tight high pressure mounting force on a cylindrical gear interior mounting surface needed to transmit with friction sufficiently high rotational torque between the shaft and the gear via the intermediate tolerance ring can be high enough to cause over time gear fractures or sufficient creep in the plastic gear material to cause loosening of the gear on the shaft for increased slop or slip at the gear-interior tolerance ring interface.

It will be appreciated that there are also some situations in which pulleys for pulley drives are also integrally mounted to shafts for common rotation like gears for gear drives (instead of being freely rotatably mounted relative to a shaft bearing). Thus the term “gear,” for purposes of this application, encompasses pulleys mounted in the same manner as gears are in the example herein.

Press fit pressure mounting methods per se are well known in the art. Also, they are not the subject of this application. Thus they need not be discussed herein.

Numerous types of gear or pulley to shaft mountings or fastenings for integral gear and shaft rotation are known in the art, including the use of annular tolerance rings between the annular shaft mounting area and the annular interior of a gear being mounted to the shaft, instead of expensive flatted, splined or keyed shafts, or the like. As is well known, such tolerance rings can be “C” shaped rather than closed rings. The following patent disclosures are noted by way of some examples of tolerance ring patents: EP Publication No. 1302685 published Apr. 16, 2003, entitled “Tolerance Ring with Friction Coating;” EP Patent No. 00373239 published Nov. 18, 1993, entitled “Tolerance Ring and Shim;” GB Publication No. 1036181 published Jul. 13, 1966, entitled “Improvements In and Relating To Tolerance Rings;” WO Publication No. 2002037479 published May 10, 2002, entitled “Cartridge Bearing with Frictional Sleeve;” WO Publication No. 2001059314 published Aug. 16, 2001, entitled “Tolerance Ring with High Hoop Strength to Resist Deformation;” WO Publication No. 1997009539 published Mar. 13, 1997, entitled “Tolerance Rings;” WO Publication No.1994029609 published Dec. 22, 1994, entitled “Tolerance Rings;” U.S. Pat. No. 6,606,224 issued Aug. 12, 2003, entitled “Cartridge Bearing with Frictional Sleeve;” and U.S. Pat. No. 6,480,363 issued Nov. 12, 2002, entitled “Hard Disk Drive Actuator Assembly with Damped Tolerance Ring for Enhancing Drive Performance During Structural Resonance Modes.”

A specific feature of the embodiment disclosed herein is to provide an improved method of press-fit pressure mounting of a gear to a gear mounting shaft using a compliant tolerance ring between the mounting shaft and the gear; said tolerance ring being mounted at least partially around said gear mounting shaft, said tolerance ring having a first circumferentially spaced pattern of varying radial dimensions, said gear having an annular interior mounting surface with a second circumferentially spaced pattern of varying radial dimensions, said gear being press-fit pressure mounted over said tolerance ring with said second circumferentially spaced pattern of varying radial dimensions of said gear annular interior mounting surface pressure intermeshing within said first circumferentially spaced pattern of varying radial dimensions of said tolerance ring to provide an interfering high torque non-slip rotational drive interconnection between said gear mounting shaft and said gear with reduced gear stress.

Further specific features disclosed herein, individually or in combination, include those wherein an improved interconnection of a gear to a gear mounting shaft with a compliant tolerance ring mounted between said gear mounting shaft and said gear, wherein said tolerance ring has a first circumferentially spaced pattern of varying radial dimensions and wherein said gear has an annular interior mounting surface with a second circumferentially spaced pattern of varying radial dimensions, which second circumferentially spaced pattern of varying radial dimensions of said gear annular interior mounting surface cooperatively engages within said first circumferentially spaced pattern of varying radial dimensions of said tolerance ring to provide a high torque rotational drive interconnection between said gear mounting shaft and said gear with reduced gear stress; and/or wherein said gear annular interior mounting surface is substantially cylindrical and said second circumferentially spaced pattern of varying radial dimensions of said gear annular interior mounting surface comprises at least four axially extending arcuate grooves in said substantially cylindrical interior mounting surface; and/or wherein said gear is plastic and said gear annular interior mounting surface is substantially cylindrical and said second circumferentially spaced pattern of varying radial dimensions of said gear annular interior mounting surface comprises anti-slip ridges molded in said substantially cylindrical interior mounting surface of said plastic gear.

As to specific components of the subject apparatus or methods, or alternatives therefor, it will be appreciated that, as is normally the case, some such components are known per se in other apparatus or applications, which may be additionally or alternatively used herein, including those from art cited herein. For example, it will be appreciated by respective engineers and others that the particular components and mountings illustrated herein are merely exemplary, and that the same novel motions and functions can be provided by many other known or readily available alternatives. All cited references, and their references, are incorporated by reference herein where appropriate for teachings of additional or alternative details, features, and/or technical background. What is well known to those skilled in the art need not be described herein.

Various of the above-mentioned and further features and advantages will be apparent to those skilled in the art from the specific apparatus and method described in the example below, including the drawing figures (which are approximately to scale) wherein:

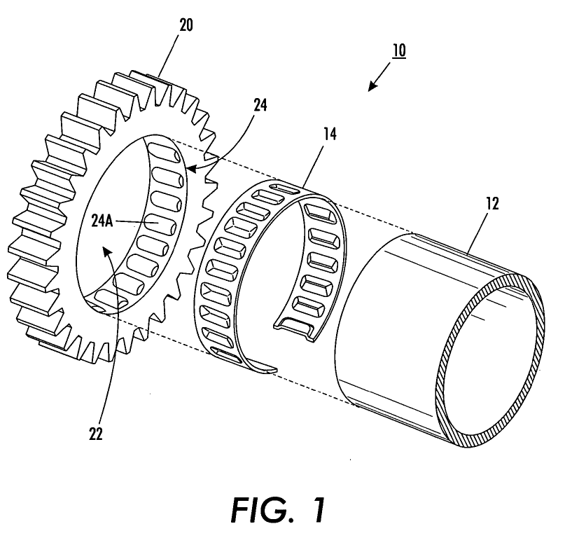

FIG. 1 is an exploded perspective view of one example of the subject gear to shaft mounting system and method, including a portion of an exemplary mounting shaft on which a modified exemplary gear and a mating exemplary conventional tolerance ring are being force-fitted;

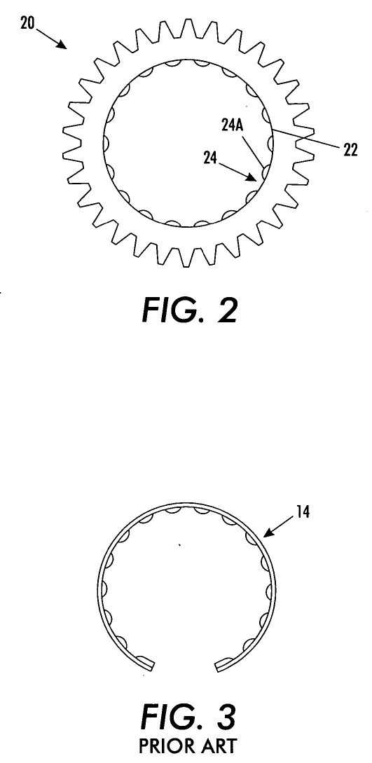

FIG. 2 is a plan view of the modified exemplary gear example of FIG. 1 per se; and

FIG. 3 is a plan view of an exemplary commercial tolerance ring shown in the example of FIG. 1.

Describing now in further detail the exemplary embodiment with reference to the Figures, there is shown an integral gear and gear mounting shaft unit 10, with otherwise conventional examples of a gear mounting shaft 12 and tolerance ring 14, and one example of a specially modified gear 20. The gear 20 may be molded plastic and have an otherwise conventional cylindrical interior mounting aperture 22, providing an annular interior mounting surface 24. However here this substantially cylindrical gear interior mounting surface 24 is modified, by molding or machining, to provide a pattern of plural radial groves and/or ridges 24A of a different radius than the substantially cylindrical surface 24. As shown, these groves and/or ridges 24A in the gear 20 are circumferentially spaced and specially adapted to mate or interdigitate with the corresponding circumferentially spaced radially varying configuration of the tolerance ring 14 so as to provide a tight, high friction, but lower gear 20 internal stress points, interconnection of the gear 20 to the gear mounting shaft 12.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. An improved method of press-fit pressure mounting of a gear to a gear mounting shaft using a compliant tolerance ring between the mounting shaft and the gear;
said tolerance ring being mounted at least partially around said gear mounting shaft,
said tolerance ring having a first circumferentially spaced pattern of varying radial dimensions,
said gear having an annular interior mounting surface with a second circumferentially spaced pattern of varying radial dimensions,
said gear being press-fit pressure mounted over said tolerance ring with said second circumferentially spaced pattern of varying radial dimensions of said gear annular interior mounting surface pressure intermeshing within said first circumferentially spaced pattern of varying radial dimensions of said tolerance ring to provide an interfering high torque non-slip rotational drive interconnection between said gear mounting shaft and said gear with reduced gear stress.

2. An improved interconnection of a gear to a gear mounting shaft with a compliant tolerance ring mounted between said gear mounting shaft and said gear, wherein said tolerance ring has a first circumferentially spaced pattern of varying radial dimensions and wherein said gear has an annular interior mounting surface with a second circumferentially spaced pattern of varying radial dimensions, which second circumferentially spaced pattern of varying radial dimensions of said gear annular interior mounting surface cooperatively engages within said first circumferentially spaced pattern of varying radial dimensions of said tolerance ring to provide a high torque rotational drive interconnection between said gear mounting shaft and said gear with reduced gear stress.

3. The interconnection of a gear to a gear mounting shaft with a compliant tolerance ring of claim 2 wherein said gear annular interior mounting surface is substantially cylindrical and said second circumferentially spaced pattern of varying radial dimensions of said gear annular interior mounting surface comprises at least four axially extending arcuate grooves in said substantially cylindrical interior mounting surface.

4. The interconnection of a gear to a gear mounting shaft with a compliant tolerance ring of claim 2 wherein said gear is plastic and said gear annular interior mounting surface is substantially cylindrical and said second circumferentially spaced pattern of varying radial dimensions of said gear annular interior mounting surface comprises anti-slip ridges molded in said substantially cylindrical interior mounting surface of said plastic gear.
